(19) United States
(12) Patent Application Publication
(10) Pub. No.: US 2012/0143700 A1
(43) Pub. Date: Jun. 7, 2012

(54) METHOD AND SYSTEM FOR DESIGNING SOCIAL MEDIA CAMPAIGN

(76) Inventors: Santanu Bhattacharya, Bangalore (IN); Ramanathan RM, Bangalore (IN); Subhashini Naidu, Bangalore (IN); Pramod Dikshith, Bangalore (IN); Ram Prasanna, Bangalore (IN); Muralidharan S., Bangalore (IN)

(21) Appl. No.: 13/242,556

(22) Filed: Sep. 23, 2011

(30) Foreign Application Priority Data
Sep. 25, 2010 (IN) 2819/CHE/2010
Sep. 25, 2010 (IN) 2820/CHE/2010

(51) Int. Cl. G06Q 30/02

(52) U.S. Cl. 705/14.72

(57) ABSTRACT

In one embodiment, a method of designing a social media campaign is provided. The method comprises steps of sourcing data from one of multiple social media channels and at least one database, performing social media indexing and benchmarking on sourced data to determine a social media index and performing campaign analytics on the social media index for designing the social media campaign.

### CROSS-REFERENCE TO RELATED APPLICATION

The present application claims priority under 35 U.S.C. 119(a) to India (IN) patent application number 2819/CHE/2010 filed Sep. 25, 2010 and IN patent application number 2820/CHE/2010 filed Sep. 25, 2010, which IN patent applications are incorporated herein by reference in their entirety.

### BACKGROUND OF THE INVENTION

1. Field of the Invention

The invention generally relates to social media campaigns. More specifically, the invention relates to designing social media campaigns.

2. Description of the Prior Art

In the Internet age of today, social media channels are an important medium for running promotional campaigns for brands, products, and services. Examples of social media channels may include, but are not limited to, social networking sites (Facebook™, Orkut™, Twitter™, MySpace™), Blogs, and video sharing sites (Youtube™). The reach of these social media channels is extensive and demographic of users accessing these social media channels is very diverse. The social media channels have access to a huge customer base and thus various companies and organizations try to aggressively utilize it to market their products, brands, and services.

The data that can be mined from these social media channels regarding access patterns of users is very useful for performing market intelligence. Using this data, marketers plan and manage their promotional campaigns on social media channels. However, the use of this data to design marketing campaigns in many conventional methods is a manual process, and thus has inconsistent and unpredictable results.

Some conventional systems use tools for extracting and analyzing this data to design social media campaigns. However, these tools are not very efficient and precise either in extracting the data or in performing analytics on the data. Thus they are not able to design directed and successful marketing campaigns.

There is therefore a need for a method and system which use efficient techniques for extracting data from social media channels and for analyzing this data, such that, the result of these analytics can be used to design successful marketing campaigns.

### SUMMARY OF THE INVENTION

In view of the foregoing disadvantages inherent in the known types of social media campaigns now present in the prior art, the present invention provides an improved method and system for designing social media campaign, and overcomes the above-mentioned disadvantages and drawbacks of the prior art. As such, the general purpose of the present invention, which will be described subsequently in greater detail, is to provide a new and improved method for designing social media campaign and system which has all the advantages of the prior art mentioned heretofore and many novel features that result in a method and system for designing social media campaign which is not anticipated, rendered obvious, suggested, or even implied by the prior art, either alone or in any combination thereof.

In one embodiment, a method of designing a social media campaign is provided. The method comprises steps of sourcing data from one of multiple social media channels and at least one database, performing social media indexing and benchmarking on sourced data to determine a social media index and performing campaign analytics on the social media index for designing the social media campaign.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

In another embodiment, the method of designing a social media campaign comprises steps of sourcing data from one of multiple social media channels and at least one database, performing social media indexing and benchmarking on sourced data to determine a social media index, performing campaign analytics on the social media index for suggesting at least one strategy for designing the social media campaign so as to obtain determined response from audience and selecting one or more social media channels among the multiple social media channels so as to suggest an optimal social medical channel mix based on a product, a brand and a service that is being marketed.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages.

FIG. 1 illustrates an exemplary environment in which various embodiments of the invention may function;

FIG. 2 is a block diagram of a system for designing and managing social media campaigns, in accordance with an embodiment;

FIG. 3 is a block diagram showing various engines in a social media indexing and Benchmarking (IB) module, in accordance with an embodiment;

FIG. 4 is a flowchart of a method of social media indexing and benchmarking, in accordance with an embodiment;

FIG. 5 illustrates computation of Reach Index (RI), in accordance with an exemplary embodiment;

FIG. 6 illustrates graphical depiction of Dimension Indices (DIs) and computation of Social Media Index (SMI) based on these DIs, in accordance with an exemplary embodiment;

FIG. 7 illustrates a representative list of various dimensions of social media and indicators associated with each of the listed dimensions;

FIG. 8 is a block diagram showing various engines in a social media Campaign Analytics (CA) module, in accordance with an embodiment;

FIG. 9 is a flowchart of a method for exploring data and performing cluster analysis, in accordance with an embodiment;

FIG. 10 illustrates segmenting of social media, in accordance with an exemplary embodiment;

FIG. 11 is a flowchart of a method for analyzing data, in accordance with an embodiment;

FIG. 12 is a flowchart of a method for creating an engagement map for social media channels, in accordance with an embodiment; and

FIG. 13 illustrates an engagement map, in accordance with an exemplary embodiment.

### DETAILED DESCRIPTION OF THE INVENTION

Before describing in detail embodiments, it should be observed that the embodiments reside primarily in combinations of method steps and system components related methods and systems for designing social media campaigns. Accordingly, the system components and method steps have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions.

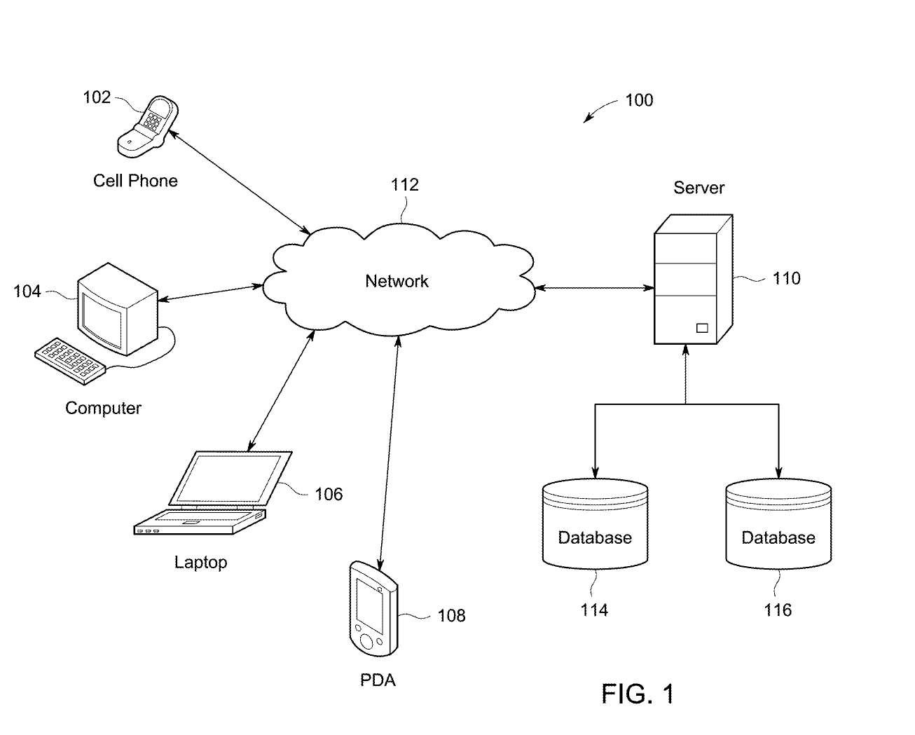

FIG. 1 illustrates an exemplary environment 100 in which various embodiments of the invention may function. Environment 100 includes one or more clients (for example, a client 102, a client 104, a client 106, and a client 108) and a server 110. Example of the one or more clients may include, but are not limited to, a computer, a laptop, a Personal Digital Assistant (PDA), a mobile phone, and a smart phone. The one or more clients may communicate with server 108 through a network 112. Network 112 may be a wired or a wireless network.

The one or more clients may communicate with server 110 to request some information. To provide this information, server 110 may further communicate with one or more databases (for example, a database 114 and a database 116) to extract data and perform proprietary analytics on the data. In another scenario, server 110 may initiate communication with the one or more clients to extract some information and store it on the one or more databases. The information may include, but is not limited to, applications and services used on a client, websites visited on the client, and information related to users of the client.

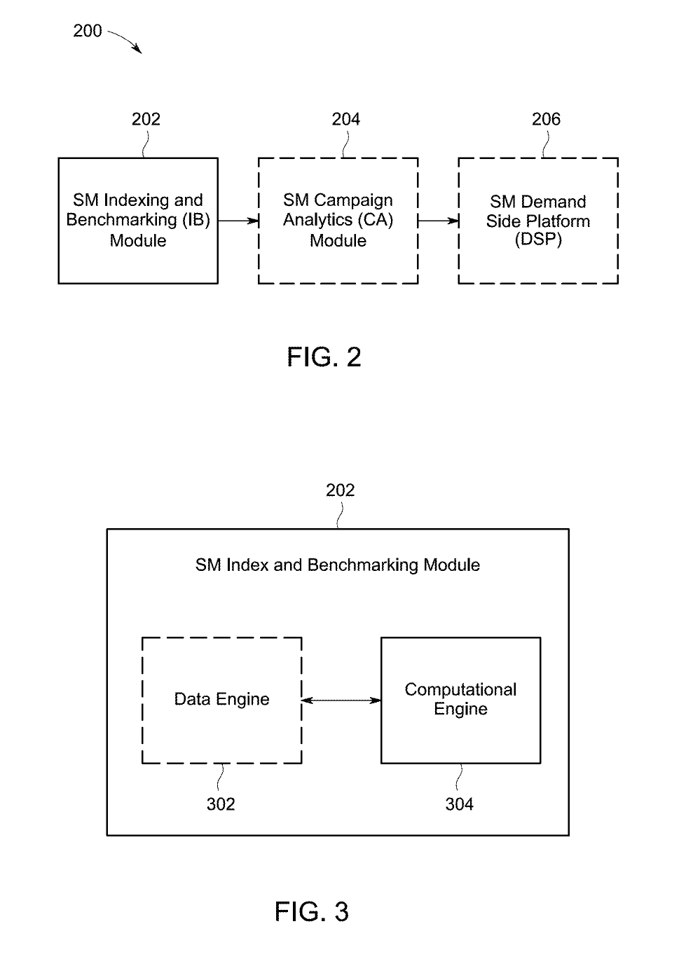

FIG. 2 is a block diagram of a system 200 for designing and managing social media campaigns, in accordance with an embodiment. System 200 includes a social media Indexing and Benchmarking (IB) module 202, a social media Campaign Analytics (CA) module 204, and a social media Demand Side Platform (DSP) 206. Each of Social media IB module 202, social media CA module 204, and social media DSP 206 may reside on server 110. In this case, the one or more clients access social media DSP 206 through network 112. In an embodiment, social media DSP 206 may reside on the one or more clients.

Social media IB module 202 sources data required for designing social media campaigns from social media channels. Social media channels are channels that encourage social gathering and interaction in online space. Social media channels may be web or mobile based. Examples of social media channels may include, but are not limited to, blogs, Facebook™, Orkut™, Twitter™, MySpace™, and Youtube™. The data required for designing social media campaigns may additionally be sourced from the one or more clients.

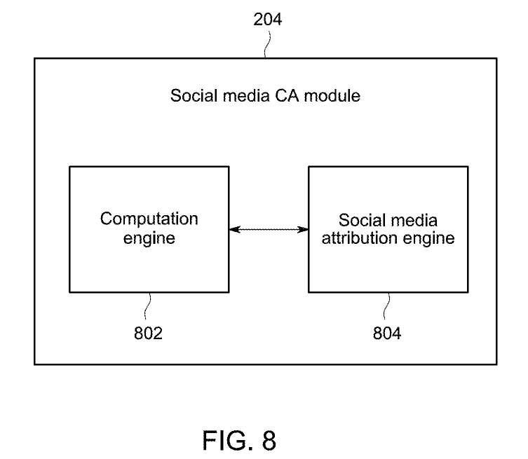

Social media IB module 202 organizes and stores this data in the one or more databases. This data is used to compute social media indices for a product, brand, or a service. These indices easily enable a user to identify relative position of the product, brand, or service when compared to competitors and thus benchmark them. This is further explained in detail in conjunction with FIG. 3. Social media CA module 204 uses these social media indices and performs additional analytics on the data stored in the one or more databases to generate end user and analytic charts. These are used by social media DSP 206 to run, monitor, and manage the social media campaign. Social media CA module 204 is explained in detail in conjunction with FIG. 8 and social media DSP 206 is explained in detail in a related application filed concurrently with the present application.

FIG. 3 is a block diagram showing various engines in social media IB module 202, in accordance with an embodiment. Social media IB module 202 includes a data engine 302 and a computation engine 304. Data engine 302 sources data from various social media channels using Application programming Interface (API) and Natural Language Processing (NLP). NLP facilitates data engine 302 to perform text mining, text parsing, and sentiment detection on social media channels.

As the data is sourced from different social media channels it has differing structures. To make this data usable, data engine 302 organizes the data into a single format and further statistically refines it such that meaningful analytics can be performed. These statistical refinements may include, but are not limited to, initialization, normalization, and deleting or pruning data that is insignificant, invalid, irrelevant, redundant, or extreme deviations from expected results. After all the formatting and refinements, data engine 302 stores the data in the one or more databases 114 ad 116 and communicates with computational engine 304.

Thereafter, computational engine 304 computes Dimension Indices (DIs) for dimensions associated with social media. The dimensions may include, but are not limited to, Reach, Engagement, Activation, Interaction, Conversion, and so forth. DIs for the one or more dimensions are computed based on one or more indicators associated with the dimensions.

Indicators for the dimensions are identified and measured from the data. Thereafter, weights are assigned to each indicator either intuitively or based on historic data. For example, Reach Index (RI) can be computed by identifying indicators that may include, but are not limited to, unique visitors and page views. Unique visitors may be identified by user registration cookies, or third-party measurement like ComScore™ or Nielsen™. Page views are counted when the page is actually viewed by a user. By way of another example, Engagement Index (EI) can be computed by identifying indicators that may include, but are not limited to, visits, repeat visits, and positive posts by each visitor. A visit is a single continuous set of activity that results in one or more pulled text and/or graphics downloads from a site. Additionally, repeat visits are the average number of times a user returns to a site within a given time period.

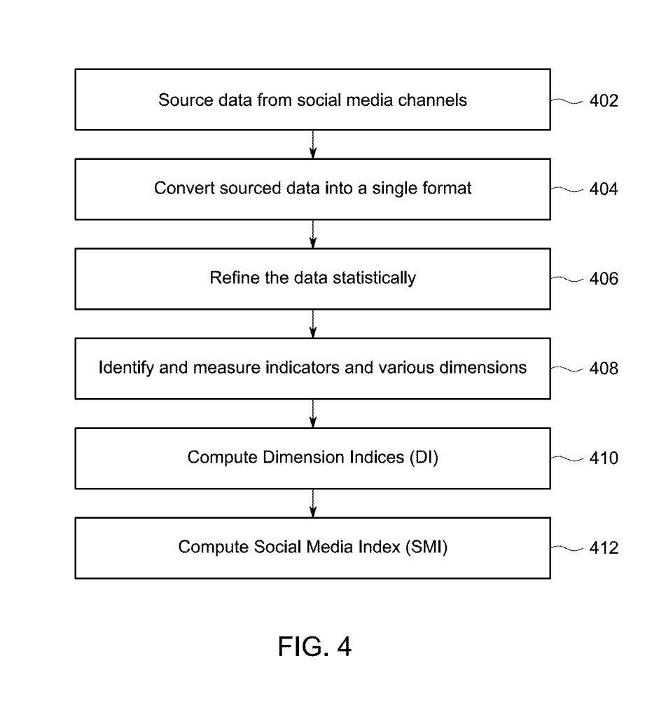

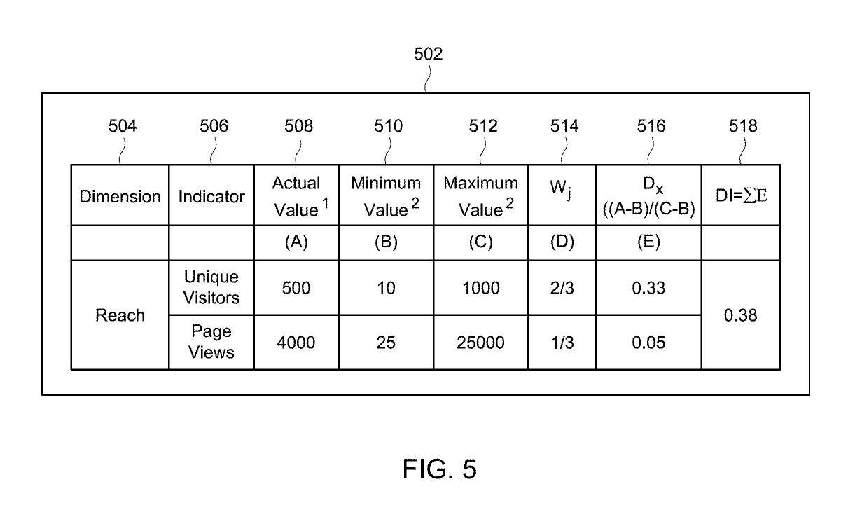

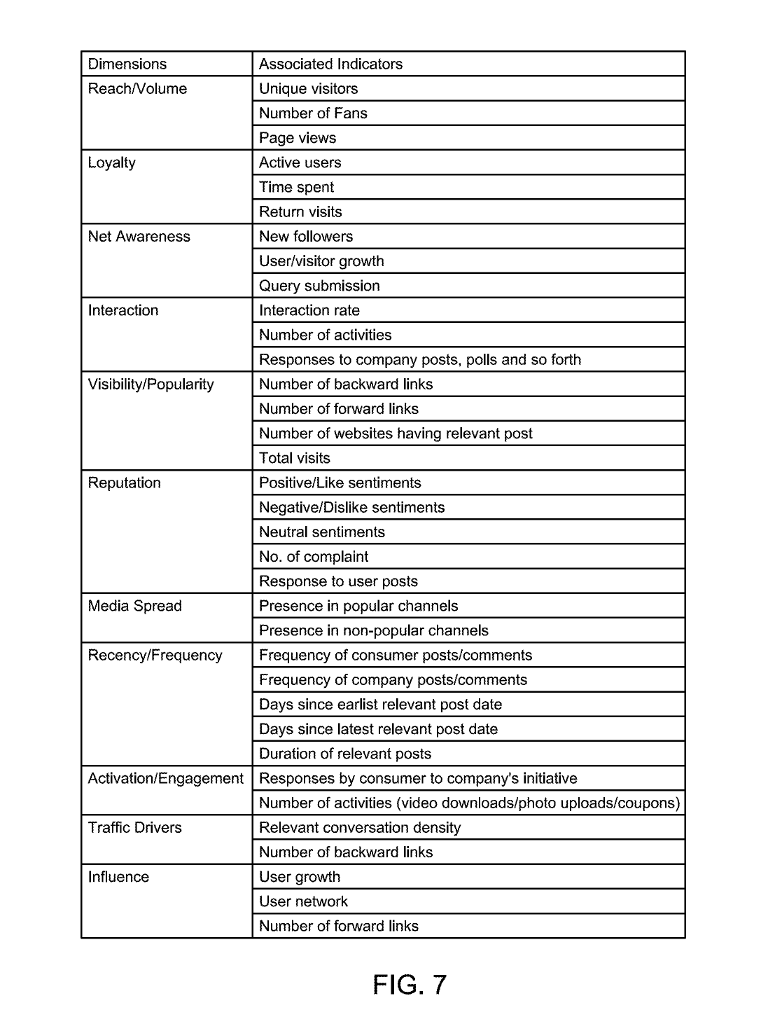

Similar to the other indices, Activation Index (AI) can be measured by identifying indicators that may include, but are not limited to, multiple responses by visitors and number of visitors responding to posts/blogs/promos. A representative list of various dimensions of social media and indicators associated with each of the listed dimensions is provided in FIG. 7. After computing the DIs, computational engine 304 computes Social Media Index (SMI) which may be the average or weighted average of all DIs. The computation of DIs and SMI is further explained in detail in conjunction with FIGS. 4 and 5.

FIG. 4 is a flowchart of a method of social media indexing and benchmarking, in accordance with an embodiment. At step 402, data engine 302 sources data from various social media channels using APIs and NLPs. Data engine 302 may use machine learning to source the data. Thereafter, at step 404, data engine 304 converts that data sourced from various social media channels into a single format. After conversion into a single format, data engine 302, at step 406, further statistically refines the data, such that, some analytics can be performed on it. The data is then saved on the one or more databases. This has been explained before in detail in FIG. 3.

After the data is ready for performing analytics, computational engine 304 uses the data to identify and measure indicators for various dimensions at step 408. Using these indicators, at step 410, computational engine 304 computes DIs. In an exemplary embodiment, computational engine 304 may apply these indicators in equation (1) given below to compute DIs:

$$DI = {\sum }_{j} {w}_{j} \times \frac{{ActualValue}_{j} - {MinimumValue}_{j}}{{MaximumValue}_{j} - {MinimumValue}_{j}} \\ Where , \\ {\sum }_{j} {w}_{j} = 1 and {w}_{j} is the weight assigned to an indicator , \qquad ( 1 )$$

Actual Value is the value of an indicator for a reference brand/product,
Minimum value is the minimum value of the indicator among the comparative brands/products,
Maximum value is the maximum value of the indicator among the comparative brands/products.

The DIs thus computed are depicted graphically and are used as an indication to determine relative position of a brand/product in comparison to its peers, with respect to a given dimension for social media. For example, an RI of 0.5 for a brand may imply that the brand has an average reach to customers through social media, when compared with its peers.

When DIs for all dimensions, for example, Reach, Engagement, and Activation, are computed, computational engine 304 computes SMI for the reference brand/product at step 412. In an exemplary embodiment, computational engine 304 may use equation (2) given below to compute SMI:

$$SMI = {\sum }_{k} {w}_{k} \times {DI}_{k} \\ Where , \\ {\sum }_{k} {w}_{k} = 1 and {w}_{k} is the weight assigned to a DI \qquad ( 2 )$$

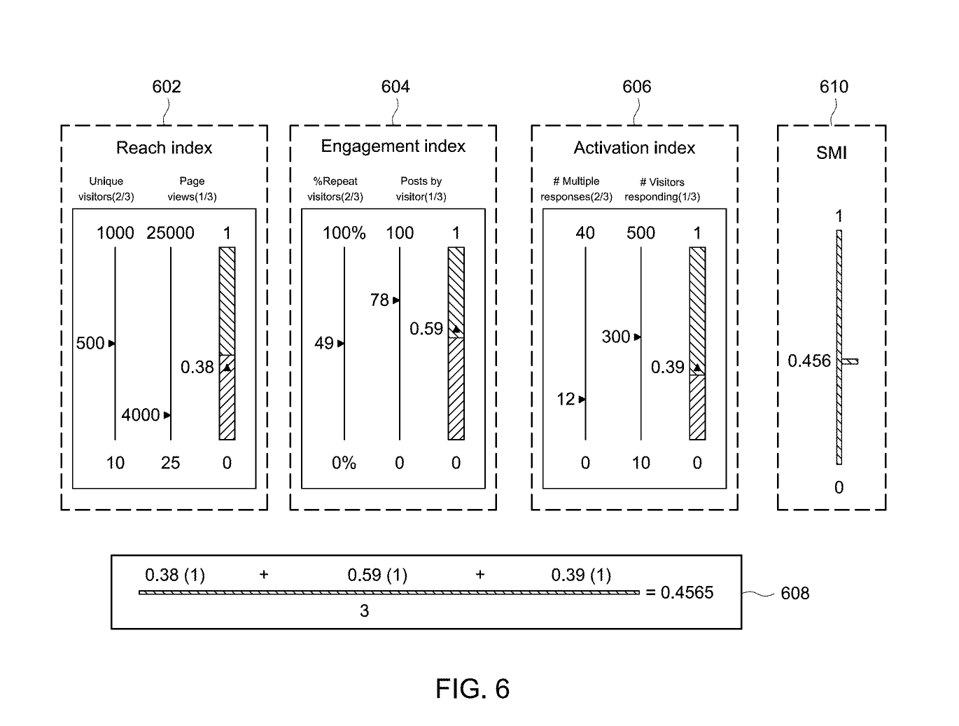

The SMI thus computed is also depicted graphically and is used as an indication to determine relative position of a brand/product in comparison to its peers, with respect to the overall SMI. For example, an SMI of 0.9 for a brand/product may imply that the brand/product is among the most popular brands/products on social media when compared with its peers. This is further explained in conjunction with exemplary embodiments of FIG. 5 and FIG. 6.

FIG. 5 illustrates computation of RI, in accordance with an exemplary embodiment. A DI computation table 502 shows computation of RI for a reference brand/product. In computation table 502, a column 504 indicates the dimension, i.e., Reach, for which the index is computed. A column 506 lists the indicators for the Reach dimension, i.e., Unique Visitors and Page Views.

The subsequent columns list the values of these indicators under various categories. A column 508 lists the actual values of these indicators measured for a reference brand/product. A column 510 lists values of these indicators measured for a comparative brand/product. These values are minimum when compared with values measured for a set of comparative brands/products. Similarly, a column 512 lists values of these indicators for another comparative brand/product, however, these values are maximum when compared with values measured for the set of comparative brands/products.

A column 514 lists the weights assigned to the indicators, i.e., Unique Visitors and Page Views. These weights may be assigned intuitively or based on historic data. All these values listed in column 508 through column 514 are applied in the equation (1), explained in the description of FIG. 4. The results are displayed in a column 516 and a column 518. Column 516 depicts indices computed individually for each indicator. The weighted mean of these indices, which is the RI, is listed in column 518. EI and AI may also be computed using similar methodology.

FIG. 6 illustrates graphical depiction of DIs and computation of SMI based on these DIs, in accordance with an exemplary embodiment. After computation of the DIs, namely, RI, EI, and AI, they are depicted through graphical representation. A graph 602 depicts the RI within a range of 0 to 1. Additionally, graph 602 depicts the indicators, which are used to determine the RI, within a range of maximum and minimum indicators values of comparative brands/products. This visual representation through a range enables a user to easily ascertain relative position of a brand/product against the comparative brands/products with respect to the indicators and the RI. Thus, a user can determine if a particular brand/product is above or below a mean or a benchmark, which may be a predefined point within a range. The predefined point may lie in the middle of the range. Similar to RI and its indicators, a graph 604 depicts EI along with its indicators and a graph 606 depicts AI along with its indicators.

Based on the DIs, SMI of the brand/product is calculated using equation (2) explained in the description of FIG. 4. As per this equation, SMI is the weighted mean of RI, EI, and AI, which are assigned equal weights. This is depicted by a block 608. After computing the SMI, it is depicted by a graph 610 within a range of 0 to 1. This enables a user to easily ascertain relative position of a brand/product against its comparative brands/products with respect to SMI.

Further, social media CA module 204 uses these SMI (social media indices) and performs additional analytics on the data stored in the one or more databases 114 and 116. Through these analytics, social media CA module 204 suggests strategies and tactics for designing social media campaigns that get positive response from audience. Additionally, social media CA module 204 also suggests an optimal social media channel mix, such that, based on a product being marketed social media channels are chosen. This is explained in more detail in conjunction with FIG. 8. The social media campaign thus designed is then monitored and managed by social media DSP 206. Social media DSP 206 is explained in detail in a related application filed concurrently with the present application.

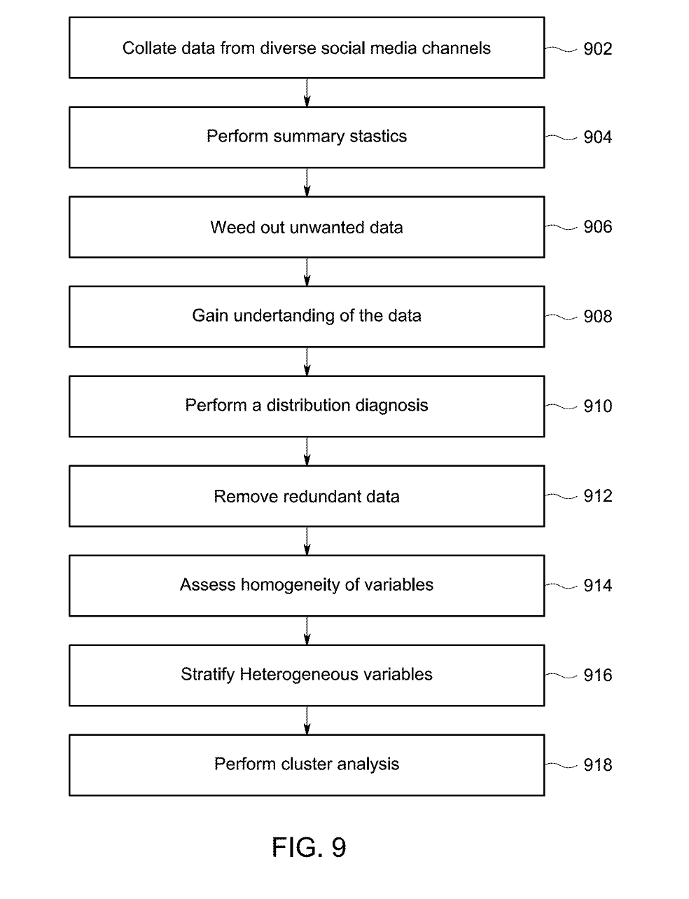

FIG. 8 is a block diagram showing various engines in social media CA module 204, in accordance with an embodiment. Social media CA module 204 includes a computation engine 802 and a social media attribution engine 804. Computation engine 802 explores the data that has been sourced from different social media channels. To this end, computation engine 804 converts the data sourced from different social media channels into a single format, identifies outliers that can have a negative impact on the overall result of the analysis, and weeds out irrelevant and redundant data. Data exploring by computation engine 802 is explained in detail in conjunction with FIG. 9.

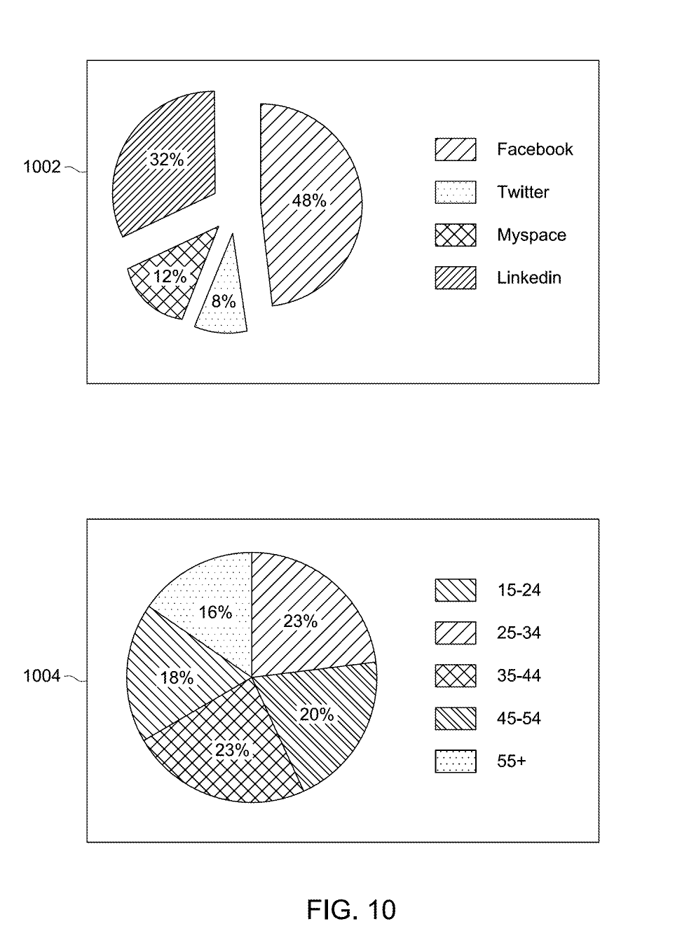

Thereafter, social media attribution engine 804 performs cluster analysis on the data. The cluster analysis is used to segment social media channels. Social media attribution engine 804 then creates an engagement map, which is used for assigning attribution to different social media channels. Thus, online spending budget for various social media channels can be optimally decided. This is further explained in detail in conjunction with FIGS. 10 and 7.

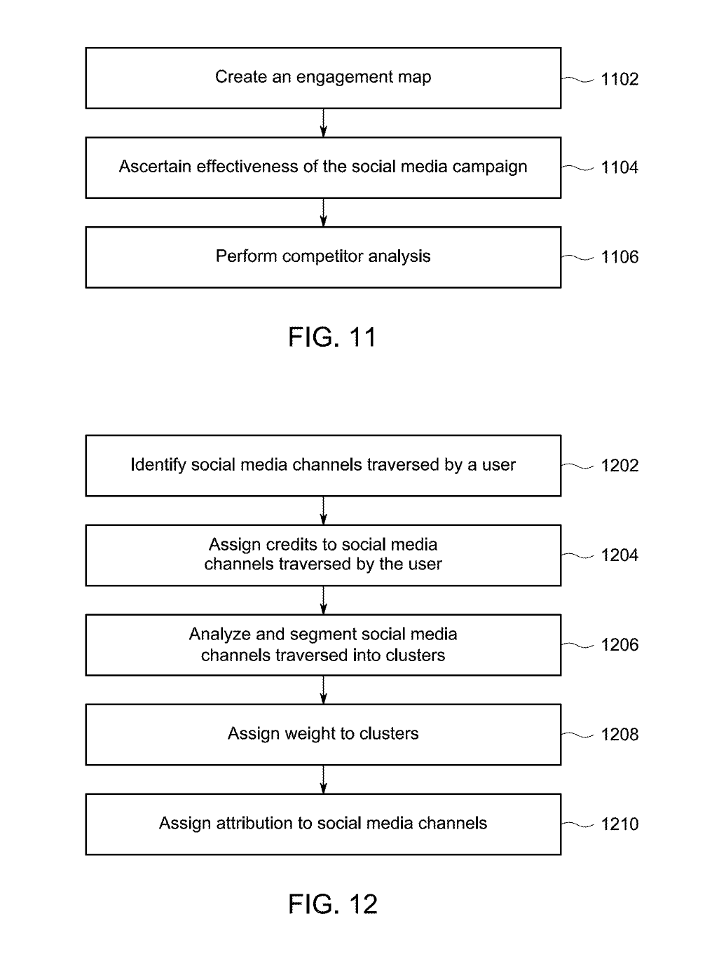

The social media campaign is run based on the assigned attribution. Computation engine 802 thereafter compares pre-campaign and post-campaign data to check if the social media campaign is running as expected and if it has effected perception for a brand/product. Computation engine 802 also extracts data for competitor and compares it with client's data for benchmarking. This is explained in detail in conjunction with FIG. 11.

FIG. 9 is a flowchart of a method for exploring data and performing cluster analysis, in accordance with an embodiment. At step 902, computation engine 802 collates data sourced from diverse media channels and converts it into a single format. Data sourced from different social media channels has a drawback of having different structures and formats. Thus, computation engine 802 takes care of converting data into a single format, inclusion/exclusion, and indexing of data. The data is then stored in the one or more databases.

Thereafter, at step 904, computation engine 802 performs summary statistics on all columns of data. This helps in identifying outliers that can have an adverse effect on the result of analysis. An outlier, for example, may be data that has an extreme deviation from data that has been extracted from a similar source. After identifying the outliers, computation engine 802 perform a check to ascertain whether the outliers are genuine or are a result of typographical error. If the outliers are a result of a typographical error, computation engine 802 estimates the missing data and substitutes the errors with the estimation. At step 906, computation engine 802 discards data that is insignificant, invalid, or irrelevant for the analysis.

The summary statistics is used by computation engine 802 at step 908, to gain an understanding of the data. Some basic hypotheses are tested using the data to ensure that the data can be used for some meaningful analysis. Examples of hypothesis assumptions may include, but are not limited to, normality of data, unique mode in data distribution, heterogeneity of data amongst demographic and other classifiers, and homogeneity of data within each demographic and other classifier. Thereafter, at step 910, computation engine 802 performs a distribution diagnosis in which the frequency distribution of the data is studied in all dimensions associated with social media. Examples of the dimensions associated with social media may include, but are not limited to, Reach, Engagement, and Activation. The frequency distribution helps in determining if any transformations can be done to the data so as to simplify analytical computations. For example, data may be transformed to normal if they are non-normal or to linear in case they are non-linear. Other examples of transformations may include, but are not limited to, reciprocal, squaring, square roots, log, or linear/nonlinear combination of variables.

At step 912, computation engine 802 removes redundant data. This is achieved by identifying interdependency of variables in the data. The variables that contribute more are retained, while other variables are not considered for analysis, and thus removed. Examples of redundant data may include, but are not limited to, linear correlation of data for two or more variables, one-to-one related variables, super set variables, and so forth. Thereafter, at step 914, computation engine 802 assesses homogeneity of variables. Some variables may turn out to be heterogeneous. For such variables, a check is performed to ascertain if this heterogeneity is explained by demographic classifiers. If there is a sound explanation, heterogeneous variables are retained, otherwise, at step 916; computation engine 802 stratifies these heterogeneous variables.

Thereafter, at step 918, social media attribution engine 804 performs cluster analysis. Through cluster analysis, social media attribution engine 804 identifies objects, individuals, or variables and classifies them on the basis of their similarity into clusters. This helps in minimizing variance within a cluster while maximizing variance between clusters. Thus, a plurality of heterogeneous clusters are formed. Each heterogeneous cluster includes homogeneous contents. The advantage of performing cluster analysis is that the data structure is simplified and some hidden relationships between cases can be identified. Additionally, the cluster analysis is used to segment social media. Social media segmentation is useful in identifying audience segments for the purpose of targeting for diverse campaigns. This is further explained in detail in conjunction with FIG. 10.

FIG. 10 illustrates segmenting of social media, in accordance with an exemplary embodiment. The cluster analysis of the data explained above is used to segment social media. To this end, hierarchical and non-hierarchical clustering analysis is applied for social media segmentation. The data that is required to enable this may include, but is not limited to, geographic data (for example, Region, country etc), psychographic data (for example, consumer response, sentiment, etc), socio-demographic data (for example, age, gender, occupation etc), and competitors data.

The social media may be segmented to ascertain which social media channel can be the most valuable for running a campaign. The result of such an analysis is depicted in a graph 1002, which clearly shows the most valuable social media channel, i.e., Facebook™. Such an analysis helps in setting advertising and promotion strategies effectively in the social media channels. The social media may further be segmented based on demographics. For example, a particular social media channel may be segmented based on usage by age. The result of this analysis is depicted in a graph 1004. Clearly, the age groups between 15-24 and 35-44 are the most active on the particular social media channel. Thus, campaigns that would be run on this social media channel should primarily be targeted at these age groups. Social media campaigns launched based on such analysis enhances the performance of social media and facilitates efficient use.

Social media channels may further be segmented based on the purpose of usage. Social media channels may be used for various purposes, for example, job searches, keeping in touch with friend, making new friends, sharing hobbies, and for fun. This again helps companies and organizations to run their campaign in a directed manner. For example, if a company wants to run a campaign that would attract talent, then a social media channel that is widely used for job searched should primarily be targeted. This helps to satisfy the customer needs and optimizes social media networking.

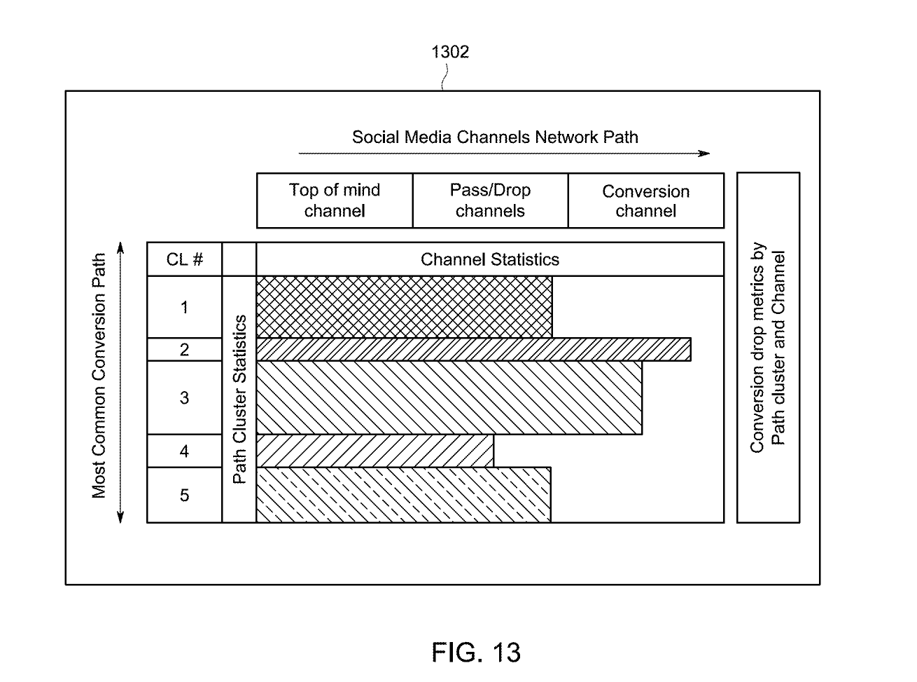

FIG. 11 is a flowchart of a method for analyzing data, in accordance with an embodiment. At step 1102, social media attribution engine 804 creates an engagement map. The engagement map is extensively used for post campaign analysis. It helps ascertaining how social media channels helped in getting conversions. This can be used by a marketer for future campaigns. The engagement map data is also archived and tagged so that it can be used for predictive modeling. The engagement map is explained in more detail in conjunction with FIG. 12. An engagement map 1302 is illustrated in FIG. 13, in accordance with an exemplary embodiment.

At step 1104, computation engine 804 ascertains effectiveness of a social media campaign. The data for a campaign that is running is continuously collected. This data is then processed to obtain measures, for example, reach, engagement, popularity, and sentiment. All this data is archived to constitute time series of data. Thereafter, pre-campaign and post-campaign data are compared to ascertain if the campaign has effected perception of a brand. Thus the performance of a campaign can be adjudged and insights can be drawn for any future campaigns.

Thereafter, at step 1106, computation engine 802 performs competitor analysis. To this end, computation engine 802 continuously collects data for competitors. Similar to the client data, competitor data is also processed to obtain measures and this data is archived to constitute time series of data. This competitor analysis can be used for benchmarking.

FIG. 12 is a flowchart of a method for creating an engagement map for social media channels, in accordance with an embodiment. At step 1202, social media attribution engine 804 identifies social media channels that have been traversed by a user. In the engagement map, social media channels are classified as top of mind channels, pass/drop channels, and conversion channels. A top of mind channel is the first channel that a user who intends to generate response to a campaign accesses/touches; a pass/drop channel is a channel after which a user looses interest in the campaign; and a conversion channel is a channel which generates business for a company.

After identifying the social media channels, social media attribution engine 804 assigns credits to the social media channels traversed by a user at step 1204. A top of mind channel is given larger credit, as it will be the first touch channel for a prospective customer. All the channels traversed by the user after the top of mind channel are assigned equal weights and the channel where a user drops is penalized in assigning weights. The conversion channels are given credits based on the business generated by them.

Thereafter, at step 1206, social media attribution engine 804 analyzes and segments all the social media channels traversed by users into clusters. Each cluster includes channels that almost every user in the cluster must have traversed through. Each cluster is then assigned weight based on strength of the cluster by social media attribution engine 804 at step 1208. For example, a cluster may be assigned weight based on number of units in the cluster, the benefit derived from cluster, the variability within and between clusters, and so forth. Based on the information obtained above, social media attribution engine 804 notionally assigns attribution to social media channels. The attribution helps marketers to develop optimal social media mix and make right budgeting decisions achieve campaign effectiveness. Additionally, this attribution helps in deriving best mix of campaign attributes for diverse campaigns.

The method for designing social media campaigns as described or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method.

The computing device executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the computing device to perform specific tasks such as the steps that constitute the method. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the computing device may be in response to user commands, or in response to results of previous processing or in response to a request made by another computing device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of designing a social media campaign, the method comprising:
sourcing data from one of multiple social media channels and at least one database;
performing social media indexing and benchmarking on sourced data to determine a social media index; and
performing campaign analytics on the social media index for designing the social media campaign.

2. The method of claim 1, further comprising:
suggesting at least one strategy for designing the social media campaign so as to obtain determined response from audience; and
selecting one or more social media channels among the multiple social media channels so as to suggest an optimal social medical channel mix based on a product, a brand and a service that is being marketed.

3. The method of claim 1, wherein the method of social media indexing and bench marking comprises:
converting the data sourced from the social media channels into a predetermined format;
statistically refining data so as to enable analytical performance of the data;
computing a dimension index for each of one or more dimensions associated with each of the social media channels;
computing a social media index for at least one of a product, a brand and a service based on the dimension index; and
determining relative position of the product, brand and service based on the social media index.

4. The method of claim 3, wherein computing the dimension index comprises:
identifying and measuring one or more indicators for each of the dimensions; and
computing the dimension index based on the measured indicators.

5. The method of claim 4, wherein the one or more dimensions comprise reach, engagement, activation, interaction and conversion.

6. The method of claim 5, wherein the social media index is a weighted mean of the one or more dimensions.

7. The method of claim 1, wherein the method of performing campaign analytics comprises:
converting the data sourced from the social media channels into a predetermined format;
performing summary statistics on the data;
processing data to simplify analytical computations;
removing redundant data;
performing cluster analysis on the data;
segmenting the social media channels based on the cluster analysis so as to identify one or more audience segments;
assigning an attribution to each of the social media channels based on segmentation; and
designing a social media campaign based on the attribution.

8. The method of claim 7, wherein the method of performing summary statistics comprises:
identifying one or more outliers, the outlier being data that exceeds a predetermined deviation; and
performing a check to ascertain genuineness of each of the outliers.

9. The method of claim 7, wherein the method of processing data comprises:
discarding undesired data, the undesired data being data that is categorized into at least one of insignificant, invalid and irrelevant categories;
analyzing the data based on one or more predetermined hypothetic assumptions; and
performing a distribution diagnosis so as to simplify analytical computations.

10. The method of claim 7, wherein the method of performing distribution diagnosis comprises determining a frequency distribution of the data concerning one or more dimensions associated with the social media channels.

11. The method of claim 7, wherein removing redundant data comprises:
identifying interdependency of one or more variables and retaining variables having at least a predetermined number of interdependencies; assessing homogeneity of each of the variables to identify one or more heterogeneous variables; and
stratifying identified heterogeneous variables.

12. A method of designing a social media campaign, the method comprising:
sourcing data from one of multiple social media channels and at least one database;
performing social media indexing and benchmarking on sourced data to determine a social media index;
performing campaign analytics on the social media index for suggesting at least one strategy for designing the social media campaign so as to obtain determined response from audience; and
selecting one or more social media channels among the multiple social media channels so as to suggest an optimal social medical channel mix based on a product, a brand and a service that is being marketed.

13. The method of claim 12, wherein the method of social media indexing and bench marking comprises:
converting the data sourced from the social media channels into a predetermined format;
statistically refining data so as to enable analytical performance of the data;
computing a dimension index for each of one or more dimensions associated with each of the social media channels;
computing a social media index for at least one of a product, a brand and a service based on the dimension index; and
determining relative position of the product, brand and service based on the social media index.

14. The method of claim 13, wherein computing the dimension index comprises:
identifying and measuring one or more indicators for each of the dimensions; and
computing the dimension index based on the measured indicators.

15. The method of claim 14, wherein the social media index is a weighted mean of the one or more dimensions.

16. The method of claim 12, wherein the method of performing campaign analytics comprises:
converting the data sourced from the social media channels into a predetermined format;
performing summary statistics on the data;
processing data to simplify analytical computations;
removing redundant data;
performing cluster analysis on the data;
segmenting the social media channels based on the cluster analysis so as to identify one or more audience segments;
assigning an attribution to each of the social media channels based on segmentation; and
designing a social media campaign based on the attribution.

17. The method of claim 16, wherein the method of performing summary statistics comprises:
identifying one or more outliers, the outlier being data that exceeds a predetermined deviation; and
performing a check to ascertain genuineness of each of the outliers.

18. The method of claim 16, wherein the method of processing data comprises:
discarding undesired data, the undesired data being data that is categorized into at least one of insignificant, invalid and irrelevant categories;
analyzing the data based on one or more predetermined hypothetic assumptions; and
performing a distribution diagnosis so as to simplify analytical computations.

19. The method of claim 16, wherein the method of performing distribution diagnosis comprises determining a frequency distribution of the data concerning one or more dimensions associated with the social media channels.

20. The method of claim 16, wherein the method of removing redundant data comprises:
identifying interdependency of one or more variables and retaining variables having at least a predetermined number of interdependencies;
assessing homogeneity of each of the variables to identify one or more heterogeneous variables; and
stratifying identified heterogeneous variables.
